(19) United States
(12) Patent Application Publication
(10) Pub. No.: US 2005/0243972 A1
(43) Pub. Date: Nov. 3, 2005

(54) Interface apparatus and method of interfacing a monitoring system

(76) Inventors: Roderick Cameron McKinnel, Haddington (GB); David John Watson, Dunfermline (GB)

Correspondence Address: Paul D. Greeley, Esq.;Ohlandt, Greeley, Ruggiero & Perle, L.L.P., 10th Floor, One Landmark Square, Stamford, CT, 06901-2682, US

(21) Appl. No.: 11/100,843

(22) Filed: Apr. 7, 2005

(30) Foreign Application Priority Data
Apr. 28, 2004 (GB) 0409468.6

(51) Int. Cl. H04M 1/24; H04M 3/08

(52) U.S. Cl. 379/32.01; 379/29.01

(57) ABSTRACT

Known probe-based network monitoring systems, whilst providing may benefits to network operators wishing to monitor various aspects of their network, have a cost implication associated with them in relation to the setting-up of taps. Also, the use of such systems may become problematic if network operators decide to encrypt signalling data. Whilst a probe-less monitoring system exists, it requires a compatible switch to be provided from the same manufacturer of the probe-less monitoring system. The present invention overcomes these difficulties by providing an interface for use with a monitoring system otherwise incapable of supporting direct connection with a network element. The interface is provide identity information compatible with the monitoring system in response to receipt of identity information compatible with the network element

The present invention relates to, inter alia, an interface apparatus for a monitoring system, for example, of the type capable of analysing a feed of data from a network element, such as a feed of data provided substantially in accordance with Signalling System No. 7, whether as specified by the CCITT, ANSI, ETSI (4 GSM), Belcore or similar body, such as a network being herein referred to as an SS No. 7 network. The CCITT Signalling System Number 7 is specified in Recommendations Q.700-Q.716 CCITT Volume VI-Fascicle VI.7, Geneva 1989, ISBN 92-61-03511-6. The feed of data may also originate from communications networks operating substantially in accordance with other communications standards, such as a network supporting a General Packet Radio Service (GPRS), or a Universal Mobile Telecommunications System (UMTS) network. The present invention also relates to a method of interfacing a monitoring system, and/or a network element for use in combination with the monitoring system.

In modern switched telecommunications systems (in particular, modern PSTNs), it is becoming increasingly possible to communication signalling information and content using frames or packets of data. One example of such a way of communicating information is so-called “Voice over IP” communications. In other, less advanced systems, it has become common practice to provide two related but separate network infrastructures: a bearer or transmission network for carrying end-user voice and data traffic, and a signalling network for controlling the setup and release of bearer channels through the bearer network in accordance with control signals transferred through the signalling network. In practice, such signalling networks comprise high-speed computers interconnected by signalling links; computer programs control the computers to provide a set of operational and signalling functions in accordance with a standardised protocol. One example of such a signalling protocol is the aforementioned Signalling System Number 7 (SS7), which is being extensively deployed for control of telephone and other data transmission networks. In addition, SS7 is also being deployed in packet switched networks that do not employ separate network infrastructures.

An SS7 network basically comprises various types of signalling points, namely, Signalling End Points (SEP's), for example an end office or local exchange, and Signalling Transfer Points (STP's) interconnected by signalling links, the SEP's being associated for example with respective Signalling Switching Points (SSP's) of the transmission network, and with Service Control Points (SCP's).

The signalling links described above are used for passing both signalling information and user packet data between nodes in the signalling network. The signalling information is carried in signalling data frames. In accordance with traditional SS7, the signalling data frames can take the form of Signalling Units, for example Fill-In Signal Units (FISUs), Link Status Signal Units (LSSUs), and Message Signal Units (MSUs), for low-speed SS7, Protocol Data Units for high-speed SS7, and user data packets for Internet Protocol (IP). For each of these, the individual signalling data frames and user data packets are carried as part of a protocol stack. The data frames and/or data packets can be handled as raw data by a monitoring system or converted into measurement records, for example, Call Detail Records (CDR's) for use by higher level applications that provide call-related monitoring. In addition to information relating to calls, signalling data frames also carry non-circuit related information, for example relating to intelligent network services, between signalling points (network nodes). Such services are provided using so-called Transaction Capabilities Application Part (TCAP) messages relating to SSP and SCP queries and responses. In mobile networks, TCAP messages carry the Mobile Application Part (MAP) messages sent between switches and databases to authenticate users, identify equipment, and enable roaming. The TCAP messages relating to an individual transaction can be correlated to form a Transaction Detail Record (TDR) as used by the higher level applications. Alternatively, messages can be handled without translation at the point of monitoring by other applications, for example a Protocol Analysis application.

The above described messages can be processed by monitoring systems, for example Agilent Technologies, Inc.'s acceSS7 software suite, to manage the telecommunications networks. The type of measurements provided can be used for such diverse purposes as Billing, Fraud Detection, Quality of Service (QoS), Network Assurance Management, and Business Intelligence.

The acceSS7 software suite is supported by monitoring hardware comprising a plurality of interface cards respectively coupled to monitoring processors that provide processing resources for the acceSS7 applications. In order to obtain copies of the MSUs communicated between the nodes in the signalling network, each interface card has an appropriate physical connector that depends upon the type of interface to be supported. The interface card is physically connected to parts of a communications network where live traffic flows in order to obtain copies of the MSUs.

In relation to packet switched networks that do not employ separate network infrastructures, and more generally, packets containing signalling data and/or content are simply communicated between nodes of the network and copies of the packets or frames are obtained via the network interfaces in the same way as described above in relation to the MSUs.

However, such tapping of the bearers adds to the cost and complexity of the monitoring system, thereby presenting a financial barrier to some telecommunications network providers to deploy monitoring systems widely throughout their networks.

Additionally, as telecommunications network operators become increasingly security conscious, the operators may be forced by standards or regulatory authorities to encrypt the data on their networks. Deciphering ciphered data or decrypting encrypted data will be very challenging for monitoring systems and may also be near-impossible to effect in real-time, thereby diminishing the value of monitoring systems that the network operators have come to depend upon for network, service, revenue and customer assurance applications.

A probeless data acquisition system, one called “Sentinel™” by Tekelec, is known and obviates a number of the above disadvantages. However, the probeless system is integrated with a switch supplied by Tekelec and so customers are limited to a single source of both switch and monitoring system. If a network operator's network comprises switches from different switch manufacturers, it will be necessary to monitor certain network elements using conventional probebased monitoring systems, and this is not possible using the above probeless data acquisition system.

According to a first aspect of the present invention, there is provided an interface apparatus for supporting communication between a data processor of a monitoring system and a network element of a communications network, the apparatus comprising: a processing unit, a data input for receiving data from the network element, and a data output for communicating at least part of the data to the data processor of the monitoring system, the processing unit being coupled to the data input and the data output; wherein the processing unit supports a mapping entity for providing, when in use, received data comprising first identification data compatible with the network element with second identification data compatible with the monitoring system, the first and second identification data identifying a data flow.

Mappings may be provided through the use of a first set of rules. The rules may map the first identification data against the second identification data so as enable mapping of data from the network element into terminology of the monitoring system and/or data from the monitoring system into terminology of the network element. The rules may be provided by a remote server.

The processing unit may be arranged to transmit the received data to a destination address for receipt by a destination processing entity of the monitoring system.

The apparatus may further comprise a transport mechanism for communicating the data from the network element to the data input. The transport mechanism may be supported by an Ethernet protocol.

The apparatus may further comprise a timing source for synchronising the network element with the monitoring system.

The apparatus may further comprise an NTP server or a UTC server.

The processing unit may be arranged to receive configuration data associated with the network element. The configuration data may be communicated, when in use, out-of-band. A second set of rules may be provided for processing the configuration data. The processing unit may implement the second set of rules.

The apparatus may further comprise a telemetry data entity for communicating with the network element, and arranged to communicate a parameter associated with the status of the monitoring system or the network element therebetween. The interface apparatus may process telemetry data using a third set of rules.

The network element may be a switch.

The apparatus may be arranged to replace redundant data in a field of the received data with the second identification data.

The data may be a frame or a packet constituting a part or whole of a message. The frame or packet may comprise a plurality of fields. One of the plurality of fields may be associated with the purpose of the packet or frame. Another of the plurality of fields may be a Media Access Control (MAC) address field. The MAC address field may contain the redundant data.

According to a second aspect of the present invention, there is provided a monitoring system comprising the interface apparatus as set forth above in accordance with the first aspect of the present invention.

The monitoring system may comprise one or more processing card coupled to the interface apparatus. The one or more processing card is arranged to receive the at least part of the data received by the interface apparatus.

According to a third aspect of the present invention, there is provided a method of interfacing a data processor of a monitoring system with a network element of a communications network, the method comprising the steps of: receiving data at a data input associated with the network element; providing the received data comprising first identification data compatible with the network element with second identification data compatible with the data processor of the monitoring system, the first and second identification data identifying a data flow; and communicating at least part of the received data including the second identification data via a data output for receipt by the data processor of the monitoring system.

According to a fourth aspect of the present invention, there is provided a computer program element comprising computer program code means to make a computer execute the method as set forth above in relation to the third aspect of the invention.

The computer program element may be embodied on a computer readable medium.

According to a fifth aspect of the present invention, there is provided a network element comprising: a processing unit arranged to generate and communicate data for receipt by a data processor of a nonintegrated monitoring system, the processing unit being capable of transmitting the data in accordance with a predetermined transport mechanism; and a synchronisation entity for ensuring synchronism with the monitoring system.

It is thus possible to provide a network monitoring system that is capable of monitoring a communications network by receiving signalling and/or content data from a network element as opposed to through tapping of communications between network nodes. Additionally, monitoring of the communications network is possible irrespective of whether or not data is encrypted, whilst not being dependent upon a single-source switch. Consequently, a network operator can benefit from the advantages of not using taps to monitor data, whilst enjoying the advantages of a reduction in overheads associated with the provision of taps. Further, the monitoring system is still capable of performing tapped monitoring if desired.

At least one embodiment of the invention will now be described, by way of example only, with reference to the accompanying drawings, in which:

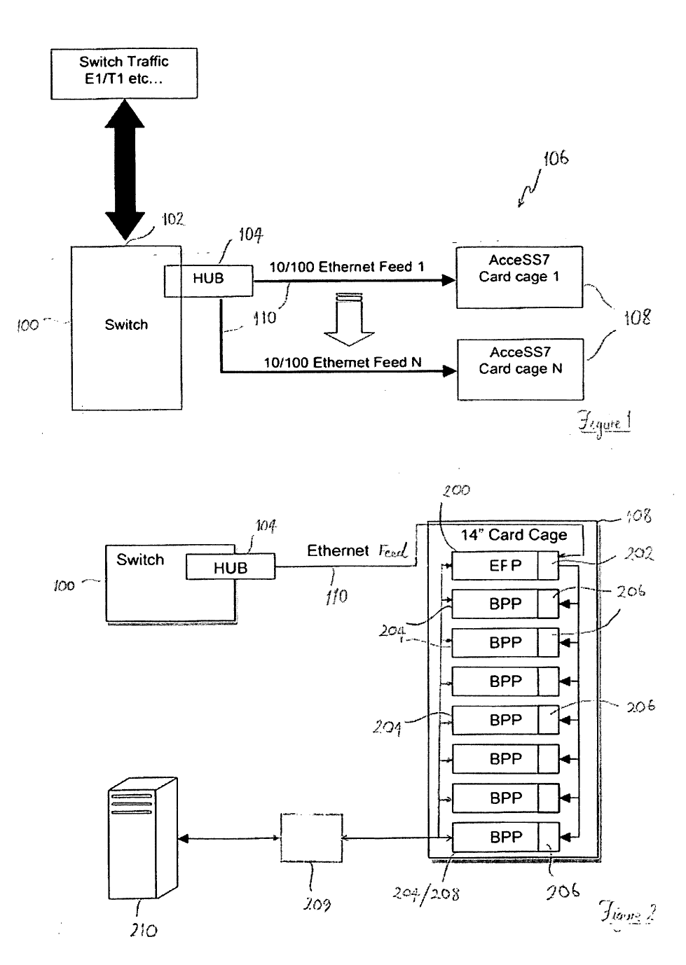

FIG. 1 is a schematic diagram of an apparatus constituting an embodiment of the invention;

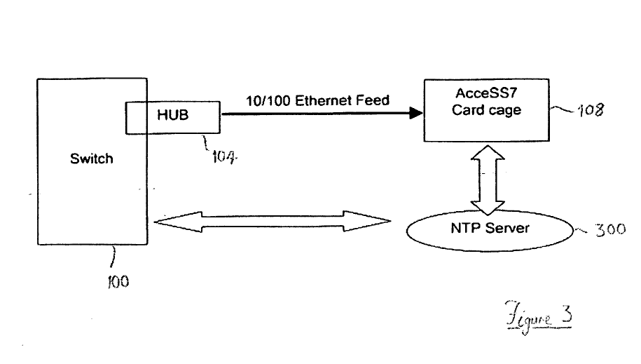

FIG. 2 is a schematic diagram of the apparatus of FIG. 1 in greater detail; and

FIG. 3 is a schematic diagram of an arrangement for ensuring synchronism between elements of FIG. 1 and/or FIG. 2.

Throughout the following description identical reference numerals will be used to identify like parts.

A communications network comprises a plurality of interconnected network elements. In the present example (FIG. 1), one such network element, a telecommunications switch 100, is capable of communicating traffic, including content and signalling information, via a plurality of input and output ports 102.

The switch 100 comprises an Ethernet hub 104 for communicating data, for example MSUs, to a network monitoring system 106. In this example, Ethernet, more particularly 10/100 Ethernet conforming to the known Ethernet II standard, is the protocol being employed to support a transport mechanism. However, it should be appreciated that other, alternative, suitable transport mechanisms can be employed, such as IEEE 802.3.

The monitoring system 106 comprises a plurality of so-called “cages” 108, each comprising hardware cards. The hub 104 is coupled to each of the card cages 108 by a respective Ethernet feed 110 in order to communicate the data to the monitoring system 106. Although not shown in FIG. 1, the monitoring system 106 comprises a central server 210 (FIG. 2) coupled to a plurality of site processors (not shown). At a given site where card cages 108 are located, a site processor 209 (FIG. 2) is provided, the site processor 209 being coupled to the card cages 108.

In relation to the transport mechanism and each respective Ethernet feed 110, the use of the Ethernet protocol allows identification of a source and a destination of a dataflow that is transmitted or received by the switch 100. In order to ensure reliability of the connection between the switch 100 and the monitoring system 106, at least one dedicated connection can be provided therebetween.

Additionally, a compression algorithm is employed to reduce the traffic load between the switch 100 and the monitoring system 106. However, it should be understood that compression does not have to be used, or a compromise of compressing selected parts of the traffic can be made, for example SS7 Fill In Signal Units (FISUs). If part-compression is employed, the transport protocol can be supplemented to supply statistical data concerning the number and frequency of packets containing the same data payload.

In this example, frame sequence numbers are also used to detect data loss between the switch 100 and the monitoring system 106, thereby improving transport quality.

Referring to FIG. 2, the monitoring system 106 also comprises a number of site processors (not shown) and a central server 210. The monitoring system is, in this example, an acceSS7 monitoring system available from Agilent Technologies, Inc. Each card cage 108 comprises an Ethernet Frame Processor (EFP) card 200. The EFP card 200 is coupled to a first Rear Transition Module card (RTM) 202. The first RTM card 202 is a communications card capable of supporting communications in accordance with the Ethernet II protocol. In this example, the first RTM card 202 has eight configurable ports, a first port (not shown) being configured to serve as an input port and coupled to one of the Ethernet feeds 110. The remaining seven ports of the first RTM card 202 are each configured as output ports and coupled to a respective Broadband Probe Processor (BPP) card 204. The BPP cards 204 are, in this example, card-mounted processors supplied by Intel® Corporation (not shown).

Each BPP card 204 is coupled to a respective two-port RTM card 206 for communicating data to the BPP card 204, and the EFP card 202 and the BPP cards 204 are coupled to the central server 210, via the site processor 209. A number of known processors (not shown) within the monitoring system 106 support a number of software applications that interpret data records generated by the monitoring system 106 for the purposes of: billing, anti-fraud, quality of service, network assurance and business intelligence. In addition, the central server 210 is capable of configuring the EFP card 200 and the BPP cards 204.

The EFP 208 comprises a mapping entity (not shown), a process that translates Ethernet data received from the hub 104, and having significance to the switch 100, to a format having significance to, and therefore compatible with, the monitoring system 106.

Whilst, in this example, the EFP card 200 and the plurality of BPP cards 204 are separate entities, it should be appreciated that a single processing card can be provided capable of carrying out all the functionality of the EFP card 200 and the functionality of one or more of the BPP cards 204. Alternatively, the EFP card 200, or an entity capable of performing the functionality of the EFP card 200, can be directly coupled and co-located with the network entity.

Referring to FIG. 3, the monitoring system 106 is designed to provide a view of the network and of the network elements from which the network is constituted. Typically, call or service related data traverse many network elements in the communications system, and the monitoring system 106 correlates these so-called ‘legs’ of a call or an activation of a service. Such correlation relies upon having a highly accurate knowledge of the time across the communications network. Consequently, the-network element being monitored and the monitoring system 106 need to be in synchronism.

In order to maintain synchronism between each of the card cages 108 and the switch 100, a time server, such as a Network Time Protocol (NTP) server 300 or a Universal Time Coordinate (UTC) server is provided. The NTP server 300 is capable of communicating identical time references to both the switch 102 and the card cage 108 for receipt by the EFP card 200 in order to allow the monitoring system 106 to correlate, accurately, traffic that establishes the legs of a call or a session, particular measurements and detail record generation. This information is then used by the applications being run by the monitoring system 106.

In order to monitor the flow of data between two nodes in a communications network, the monitoring system 106 needs to be aware of data flows between a network element, in this example the switch 102, and network nodes that surround the network element. The monitoring system 106 therefore needs a definition of the data flow emanating from the network element, as well as a definition of the network elements at both end of the data flow. Therefore, in operation, the monitoring system 106 needs to be initially, as well as periodically, configured.

The regular supply of configuration data facilitates so-called “automatic discovery” of new data flows. When a dataflow or link is added, updated or deleted during normal operation, it can be identified by the monitoring system 106 within a short period of time of the change occurring.

In order to properly identify links or data flows that are the subject of configuration messages, the configuration data contains an indication that identifies the source and destination of the data flow as well as an indication of keys that will tag actual data messages communicated by the switch 100 to the monitoring system 106.

The switch 100 is therefore arranged to generate configuration data, the configuration data being communicated to the card cage 108 via the Ethernet feed 110. Upon receipt of the configuration data, the card cage 108 forwards the configuration data to the central server 210 for processing in a manner to be described later herein.

It should be appreciated that the messages used to communicate configuration data can be in-band or out-of-band with the stream of data being monitored. Further, whilst in this example configuration data is communicated from the switch 100 to the monitoring system 106 using messages, it should be appreciated that configuration data can be stored in a file common to the switch 100 and the monitoring system 106, data being periodically stored in the common file by the switch 100 for subsequent retrieval by the monitoring system 106.

In response to receipt of the configuration data, the central server 210 configures the EFP card 200 and the BPP cards 204 individually. In relation to the EFP card 200, the configuration process comprises providing the EFP card 200 with a plurality of rules for mapping data associated with data messages received at the input port of the first RTM card 202 to one or more of the output ports of the first RTM card 202. In addition, the EFP card 200 is provided with a set of rules for processing switch status messages and a set of rules for processing telemetry messages. Of course, the EFP card 200 is pre-configured with an initial set of rules for processing configuration data that needs to be forwarded to the central server 210.

The central server 210, in addition to configuring the EFP card 200, also configures the BPP cards 204, including applications supported by the BPP cards 204, in order to instruct each BPP card 204 as to identities of links to be respectively monitored; data corresponding to the links identified are processed by the configured applications and measurements specific to the applications are produced for further processing by other processors in the monitoring system 106. These processes, in relation to the BPP cards 204 are known for the acceSS7 system.

Thereafter, once initial:configuration has taken place, the card cage 108 processes data transmitted by the switch 100. Of course, periodic, updating, configurations of the EFP card 200 and the BPP cards 204 are effected as necessary.

The data received via the first RTM card 202 of the EFP card 200 is in the form of Ethernet II frames. Upon receipt of a frame, the frame is analysed by the EFP card 200 using the set of rules provided by the central server 210 for processing incoming data frames from the switch 100. Firstly, the EFP card 200 analyses the payload of the frame to determine if the frame contains a data message. If the frame contains a data message, the EFP card 200 also determines, from the payload, a link identifier and a direction of dataflow. Optionally, the EFP card 200 can identify a switch processing card and port (not shown) associated with the data message. Thereafter, the EFP card 200 uses the set of rules provided by the central server 210 for mapping data associated with data messages and identifies one or more BPP card 204 to which the frame needs to be transmitted. Additionally, using this set of rules, the EFP card 200, tags the frame with an identifier specific to the monitoring system 106. The EFP card 200 tags the frame by replacing a redundant MAC address field of the frame with the identifier, thereby translating the identifier of the frame into a form significant to the monitoring system 106.

Once modified, the EFP card 200 transmits the modified frame to the one or more BPP card 204 identified as requiring the modified frame. Thereafter, the one or more BPP card 204 receives the modified frame and processes the modified frame based upon the identifier contained in the MAC address field of the modified frame. The processing of the frame is in accordance with normal processing of received frames, such as so-called “LAN tapped” frames generated using conventional line link tapping techniques.

In order to maintain flexibility in the monitoring system 106, the software of the BPP cards 204 is adapted to operate by receipt of frames from the EFP card 200, or by direct feeds (not shown) into one or more BPP card 204 for conventional link tapping. In the case of the latter technique, the MAC address field of received frames does not need to be analysed as the link associated with the received frame is known through configuration of the BPP card 204. Of course, this facility is only available for 10/100 links, because a different type of RTM card can be employed for different types of link, for example an E1/T1 link. In such cases, another mechanism, for example another field, can be used to communicate the link identity to the BPP card 204.

When the EFP card 200 receives configuration data, the rules associated with configuration are used by the EFP card 200 to forward the frames containing the configuration data to a nominated BPP card 208, the nominated BPP card 208 recognising the frames containing the configuration data and forwarding the frames to the central server 210.

Frames can correspond to messages containing data indicative of the status of the switch 100, or other network element and so, similarly, upon receipt of frames containing switch status data, the rules for processing the switch status messages are applied. In the present example, the rule causes the EFP card 200 to multicast the frames containing the switch status data to each of the BPP cards 204, the BPP cards 204 recognising the frames containing the switch status data and processing the frames accordingly, depending upon the content of the switch status message.

In addition to switch status messages, frames constituting telemetry messages containing management and control data are bi-directionally communicated between the switch 100 and the monitoring system 106. Such telemetry messages are desirable, but optional, for communication of status and statistical information, for example, if one or both of the switch 100 and the monitoring system 106 are encountering problems receiving and/or transmitting data flows.

Telemetry messages can be both in-band and out-of-band communications and originate either from the network element or the monitoring system 106. Further, some of the telemetry messages are periodic and/or statistical in nature, while other telemetry messages are delivered only when exceptional conditions occur. Examples of telemetry messages include messages to communicate that: the switch is functioning correctly, the switch is functioning incorrectly, there has been an NTP communications server loss, the NTP communications have been retrieved, monitoring has been suspended or re-enabled, or a processor outage exists.

In relation to any of the above messages, if ciphered or encrypted traffic is to be monitored, the network element provides suitable ‘keys’ either in- or out-of-band with the stream of dataflow being monitored. Alternatively or additionally, deciphering keys can be captured from an alternative connection. As a further alternative, the network element can communicate the messages to the monitoring system 106 free of encryption or ciphering, in which case key exchanges are not required.

Lastly, whilst not core to the invention, and so will not be described in detail, for completeness, it should be appreciated that an agreement exists, between the network element and the monitoring system 106 in respect of the time frame of the delivery of communications and also the back-off or suspension of communications in overflow or busy conditions.

Alternative embodiments of the invention can be implemented as a computer program product for use with a computer system, the computer program product being, for example, a series of computer instructions stored on a tangible data recording medium, such as a diskette, CDROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

1. An interface apparatus for supporting communication between a data processor of a monitoring system and a network element of a communications network, the apparatus comprising:
a processing unit, a data input for receiving data from the network element, and a data output for communicating at least part of the data to the data processor of the monitoring system, the processing unit being coupled to the data input and the data output; wherein
the processing unit supports a mapping entity for providing, when in use, received data comprising first identification data compatible with the network element with second identification data compatible with the monitoring system, the first and second identification data identifying a data flow.

2. An apparatus as claimed in claim 1, wherein the processing unit is arranged to transmit the received data to a destination address for receipt by a destination processing entity of the monitoring system.

3. An apparatus as claimed in claim 1, further comprising a transport mechanism for communicating the data from the network element to the data input.

4. An apparatus as claimed in claim 3, wherein the transport mechanism is supported by an Ethernet protocol.

5. An apparatus as claimed in claim 1, further comprising a timing source for synchronising the network element with the monitoring system.

6. An apparatus as claimed in claim 1, further comprising an NTP server or a UTC server.

7. An apparatus as claimed in claim 1, wherein the processing unit is arranged to receive configuration data associated with the network element.

8. An apparatus as claimed in claim 7, wherein the configuration data is communicated, when in use, out-of-band.

9. An apparatus as claimed in claim 1, further comprising a telemetry data entity capable of communicating with the network element and arranged to communicate a parameter associated with the status of the monitoring system or the network element therebetween.

10. A monitoring system comprising the interface apparatus as claimed in claim 1.

11. A method of interfacing a data processor of a monitoring system with a network element of a communications network, the method comprising the steps of:
receiving data at a data input associated with the network element;
providing the received data comprising first identification data compatible with the network element with second identification data compatible with the data processor of the monitoring system, the first and second identification data identifying a data flow; and
communicating at least part of the received data including the second identification data via a data output for receipt by the data processor of the monitoring system.

12. A computer program element comprising computer program code means to make a computer execute the method as claimed in claim 11.

13. A computer program element of claim 12, embodied on a computer readable medium.

14. A network element comprising:
a processing unit arranged to generate and communicate data for receipt by a data processor of a non-integrated monitoring system, the processing unit being capable of transmitting the data in accordance with a predetermined transport mechanism; and
a synchronisation entity for ensuring synchronism with the monitoring system.
